(19) United States
(12) Patent Application Publication
(10) Pub. No.: US 2008/0027726 A1
(43) Pub. Date: Jan. 31, 2008

(54) Text to audio mapping, and animation of the text

(76) Inventors: Eric Louis Hansen, Halifax (CA); Reginald David Hody, Halifax (CA)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/495,836

(22) Filed: Jul. 28, 2006

(51) Int. Cl. G10L 13/08

(52) U.S. Cl. 704/260

(57) ABSTRACT

Apparati, methods, and computer-readable media for creation of a text to audio chronological mapping. Apparati, methods, and computer-readable media for animation of the text with the playing of the audio. A Mapper (10) takes as inputs text (12) and an audio recording (11) corresponding to that text (12), and with user assistance assigns beginning and ending times (14) to textual elements (15). A Player (50) takes the text (15), audio (17), and mapping (16) as inputs, and animates and displays the text (15) in synchrony with the playing of the audio (17). The invention can be useful to animate text during playback of an audio recording, to control audio playback as an alternative to traditional playback controls, to play and display annotations of recorded speech, and to implement characteristics of streaming audio without using an underlying streaming protocol.

### TECHNICAL FIELD

This invention relates generally to the field of audio analysis, specifically audio which has a textual representation such as speech, and more specifically to apparatus for the creation of a text to audio mapping and a process for same, and apparatus for animation of this text in synchrony with the playing of the audio. The presentation of the text to audio mapping in the form of audio-synchronized text animation conveys far greater information than the presentation of either the audio or the text by itself, or the presentation of the audio together with static text.

In accordance with a first embodiment of the present invention, we provide an apparatus (“Phonographeme Mapper 10”) and process for creation of a text to audio mapping.

In accordance with a second embodiment of the present invention, we provide an apparatus (“Phonographeme Player 50”) for animation of the text with the playing of the audio.

The invention's Mapper 10 and Player 50 overcome deficiencies in prior technology which have in the past prevented realization of the full potential of simultaneous speech-plus-text presentations. By overcoming these deficiencies, the Mapper 10 and Player 50 open the way for improved, as well as novel, applications of speech-plus-text presentations.

### BACKGROUND ART

The first technical advances in language-based communication included the development of simple, temporally isolated meaning-conveying vocalizations. These first meaningful vocalizations then began to be combined in sequential order in the time dimension to make up streams of speech. A further step was the invention of simple, spatially isolated meaning-conveying symbols or images on cave walls or other suitable surfaces, which in time began to be associated with spoken language. These stand-alone speech-related graphics were then combined in sequential order in the spatial dimension to make up lines of written language or “text”. Specifically, our innovative ancestors began to create sequential spatial orderings of pictographic, ideographic, or phonemic characters that paralleled and partially represented sequences of time-ordered, meaning-conveying vocalizations of actual speech. This sequential ordering in two-dimensional space of characters that were both meaning-conveying and vocalization-related was a key innovation that allowed us to freeze a partial representation of the transient moving stream of speech as static and storable text.

Our ability to communicate through speech and text was further advanced by the invention of the analog processing of speech. This technical innovation allowed us to freeze and store the sounds of the moving stream of speech, rather than having to be satisfied with the partially equivalent storage of speech as text. More recently, our ability to communicate through language has been extended by the digital encoding, storage, processing, and retrieval of both recorded speech and text, the development of computerized text-searching techniques, and by the development of interactive text, including interactive text annotation and hypertext. Finally, our ability to communicate through language has been significantly advanced by the development of Internet distribution of both recorded speech and text to increasingly prevalent programmable or dedicated digital computing devices.

In summary, spoken and written language communication was made possible by two sequential orderings—first, the temporal sequential ordering of the meaning-conveying vocalizations of speech, and second, the spatial sequential ordering of pictographic, ideographic, or phonemic characters that represent the meaning-conveying vocalizations of speech. Although each of these sequential orderings provides a powerful form of language communication in its own right, the partial equivalence of speech and text also makes it possible to use one to represent or substitute for the other. This partial equivalence has proven useful in many ways, including overcoming two disability-related barriers to human communication—deafness and blindness. Specifically, persons who cannot hear spoken language, but who can see and have learned to read, can understand at least some of the meaning of what has been said by reading a transcription of the spoken words. Secondly, hearing persons who cannot see written language can understand the meaning of what has been written by hearing a transvocalization of the written words, or by hearing the original recording of speech.

For persons who can both see and hear, the synergy between speech and its textual representation, when both are presented at the same time, creates a potentially powerful hybrid form of language communication. Specifically, a simultaneous speech-plus-text presentation brings the message home to the listening reader through both of the primary channels of language-based communication—hearing and seeing—at the same time. The spoken component of a speech-plus-text presentation supports and enhances the written message, and the written component of the presentation supports and enhances the spoken message. In short, the whole of a speech-plus-text presentation is greater than the sum of its parts.

For example, seeing the lyrics of “The Star-Spangled Banner” displayed at the same time as the words of this familiar anthem are sung has the potential to create a whole new dimension of appreciation. Similarly, reading the text of Martin Luther King's famous “I have a dream” speech while listening to his voice immerses one in a hybrid speech-plus-text experience that is qualitatively different from either simply reading the text or listening to the speech.

Speech-plus-text presentations also have obvious educational applications. For example, learning to read one's native language involves the association of written characters with corresponding spoken words. This associative learning process is clearly facilitated by a simultaneous speech-plus-text presentation.

Another educational application of speech-plus-text presentations is in learning a foreign or “second” language—that is, a language that at least initially cannot be understood in either its spoken or written form. For example, a student studying German may play a speech-plus-text version of Kafka's “Metamorphosis”, reading the text along with listening to the spoken version of the story. In this second-language learning application, text annotations such as written translations can help the student to understand the second language in both its spoken and written forms, and also help the student acquire the ability to speak and write it. Text annotations in the form of spoken translations, clearly enunciated or alternative pronunciations of individual words, or pop-up quizzes can also be used to enhance a speech-plus-text presentation of foreign language material.

An industrial educational application of such speech-plus-text presentations is the enhancement of audio versions of written technical material. An audiovisual version of a corporate training manual or an aircraft mechanic's guide can be presented, with text displayed while the audio plays, and in this way support the acquisition of a better understanding of the technical words.

Speech that may be difficult to understand for reasons other than its foreignness—for example, audio recordings of speech in which the speech component is obscured by background noise, speech with an unfamiliar accent, or lyric-based singing that is difficult to understand because it is combined with musical accompaniment and characterized by changes in rhythm, and by changes in word or syllable duration that typically occur in vocal music—all can be made more intelligible by presenting the speech component in both written and vocalized forms.

Speech-plus-text recordings of actual living speech can also play a constructive role in protecting endangered languages from extinction, as well as contributing to their archival preservation.

More generally, hybrid speech-plus-text presentations create the possibility of rendering the speech component of the presentations machine-searchable by means of machine-based text searching techniques.

We will address the deficiencies in prior technology first with respect to the Mapper component 10 and then with the Player component 50 of the present invention.

Current programs for audio analysis or editing of sound can be used to place marks in an audio recording at user-selected positions. Such a program can then output these marks, creating a list of time-codes. Pairings of time-codes could be interpreted as intervals. However, time-codes or time-code intervals created in this manner do not map to textual information. This method does not form a mapping between an audio recording and the textual representation, such as speech, that may be present in the audio recording. This is why prior technology does not satisfy the function of Mapper 10 of the present invention.

We will now address prior technology related to the Player component 50 of the present invention. While presenting recorded speech at the same time as its transcription (or text at the same time as its transvocalization), several problems arise for the listening reader (or reading listener): First, how is one to keep track of the place in the text that corresponds to what is being said? Prior technology has addressed this problem in two ways, whose inadequacies are analyzed below. Second, in a speech-plus-text presentation, the individual written words that make up the text can be made machine-searchable, annotatable, and interactive, whereas the individual spoken words of the audio are not. Prior technology has not addressed the problem of making speech-containing audio machine-searchable, annotatable, and interactive, despite known correspondence between the text and the audio. Third, the interactive delivery of the audio component requires a streaming protocol. Prior technology has not addressed limitations imposed by the use of a streaming protocol for the delivery of the audio component.

The prior technology has attempted to address the first of these problems—the “how do you keep your place in the text problem”—in two ways.

The first approach has been to keep the speech-plus-text segments brief. If a segment of speech is brief and its corresponding text is therefore also short, the relationship between the played audio and the displayed text is potentially relatively clear—provided the listening reader understands both the spoken and written components of the speech-plus-text presentation. The more text that is displayed at once, and the greater difficulty one has in understanding either the spoken or written words (or both), the more likely one is to lose one's place. However, normal human speech typically flows in an ongoing stream, and is not limited to isolated words or phrases. Furthermore, we are accustomed to reading text that has not been chopped up for display purposes into word or phrase-length segments. Normal human speech—including the speech component of vocal music—appears unnatural if the transcription is displayed one word or phrase at a time, and then rapidly changed to keep up with the stream of speech. Existing read-along systems using large blocks of text or lyrics present the transcription in a more natural form, but increase the likelihood of losing one's place in the text.

Prior technology has attempted to address the place-keeping problem in a second way: text-related animation. Examples of this are sing-along aids such as a “bouncing ball” in some older cartoons, or a bouncing ball or other place-indicating animation in karaoke systems. The ball moves from word to word in time with the music to provide a cue as to what word in the lyric is being sung, or is supposed to be sung, as the music progresses. Text-related animation, by means of movement of the bouncing ball or its equivalent, also adds an element of visual interest to the otherwise static text.

The animation of text in synchrony with speech clearly has the potential of linking speech to its transcription in a thorough, effective, and pleasing way. Existing technology implements the animation of text as a video recording or as film. The drawbacks of implementing animation of text in this way are multiple:
1. The creation of such videos is time consuming and requires considerable skill.
2. The creation of such videos forms large data files even in cases where only text is displayed and audio played. Such large data files consume correspondingly large amounts of bandwidth and data storage space, and for this reason place limitations on the facility with which a speech-plus-text presentation can be downloaded to programmable or dedicated digital computing devices.
3. The animation is of a fixed type.
4. The animation is normally no finer than word-level granularity.
5. The audio cannot be played except as a part of the video.
6. Interaction with the audio is limited to the controls of the video player.
7. The audio is not machine-searchable or annotatable.
8. The text cannot be updated or refined once the video is made.
9. The text is not machine-searchable or annotatable.
10. No interaction with the text itself is possible.

### DISCLOSURE OF INVENTION

The present invention connects text and audio, given that the text is the written transcription of speech from the audio recording, or the speech is a spoken or sung transvocalization of the text. The present invention (a) defines a process for creation of such a connection, or mapping, (b) provides an apparatus, in the form of a computer program, to assist in the mapping, and (c) provides another related apparatus, also in the form of a computer program, that thoroughly and effectively demonstrates the connection between the text and audio as the audio is played. Animation of the text in synchrony with the playing of the audio shows this connection. The present invention has the following characteristics:
1. The animation aspect of a presentation is capable of thoroughly and effectively demonstrating temporal relationships between spoken words and their textual representation.
2. The creation of speech-plus-text presentations is efficient and does not require specialized expertise or training.
3. The data files that store the presentations are small and require little data-transmission bandwidth, and thus are suitable for rapid downloading to portable computing devices.
4. The animation styles are easily modifiable.
5. The audio is playable, in whole or in part, independent of animations or text display.
6. Interaction with the speech-plus-text presentation is not limited to the traditional controls of existing audio and video players (i.e., “play”, “rewind”, “fast forward”, and “repeat”), but includes controls that are appropriate for this technology (for example, “random access”, “repeat last phrase”, and “translate current word”).
7. The invention enables speech-plus-text presentations to be machine-searchable, annotatable, and interactive.
8. The invention allows the playback of audio annotations as well as the display of text annotations.
9. The invention allows the text component to be corrected or otherwise changed after the presentation is created.
10. The invention permits interactive random access to the audio without using an underlying streaming protocol.
11. The invention provides a flexible text animation and authoring tool that can be used to create animated speech-plus-text presentations that are suitable for specific applications, such as literacy training, second language acquisition, language translations, and educational, training, entertainment, and marketing applications.

### BRIEF DESCRIPTION OF THE DRAWINGS

These and other more detailed and specific objects and features of the present invention are more fully described in the following specification, reference being had to the accompanying drawings, in which various aspects of the invention may be shown exaggerated or enlarged to facilitate an understanding of the invention.

FIG. 1 is a block diagram of a digital computing device 100 suitable for implementing the present invention.

FIG. 2 is a block diagram of a Phonographeme Mapper (“Mapper”) 10 and associated devices and data of the present invention.

FIG. 3 is a block diagram of a Phonographeme Player (“Player”) 50 and associated devices and data of the present invention.

### DETAILED DESCRIPTION OF THE PREFERRED EMBODIMENTS

It is to be understood that the present invention may be embodied in various forms. Therefore, specific details disclosed herein are not to be interpreted as limiting, but rather as representative for teaching one skilled in the art to employ the present invention in virtually any appropriately detailed system, structure, or manner.

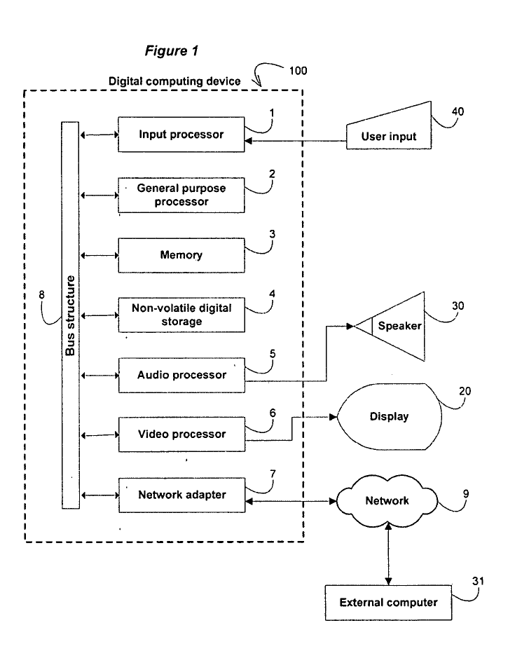

FIG. 1 shows a digital computing device 100 suitable for implementing the present invention. The digital computing device 100 comprises input processor 1, general purpose processor 2, memory 3, non-volatile digital storage 4, audio processor 5, video processor 6, and network adapter 7, all of which are coupled together via bus structure 8. The digital computing device 100 may be embodied in a standard personal computer, cell phone, smart phone, palmtop computer, laptop computer, PDA (personal digital assistant), or the like, fitted with appropriate input, video display, and audio hardware. Dedicated hardware and software implementations are also possible. These could be integrated into consumer appliances and devices.

In use, network adapter 7 can be coupled to a communications network 9, such as a LAN, a WAN, a wireless communications network, the Internet, or the like. An external computer 31 may communicate with the digital computing device 100 over network 9.

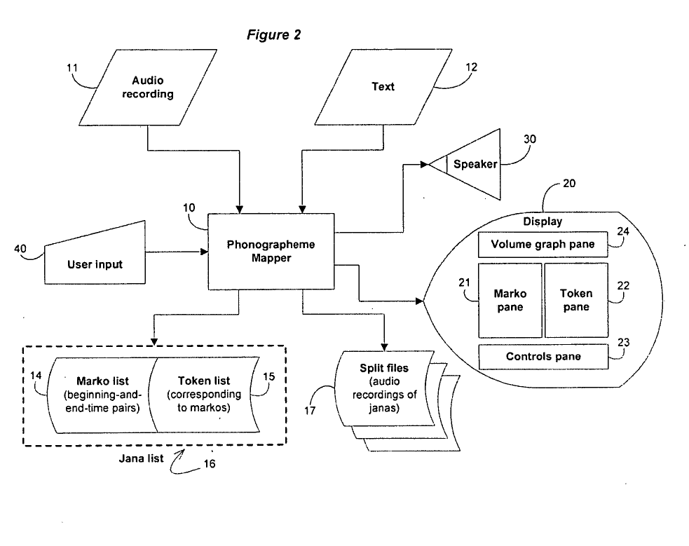

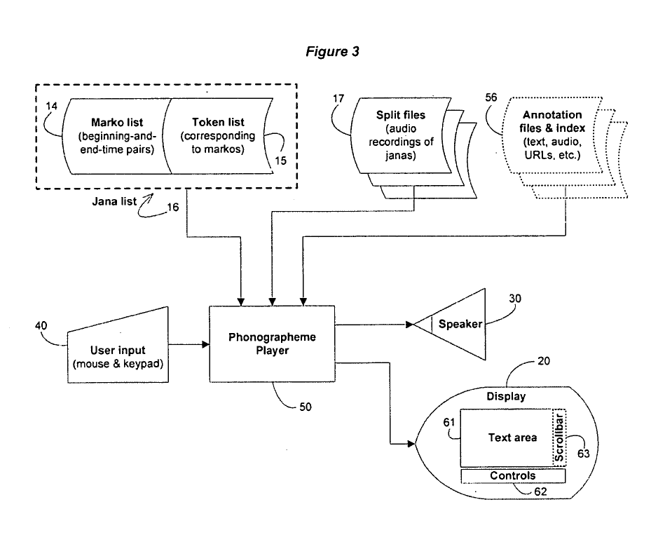

FIG. 2 depicts Phonographeme Mapper (“Mapper”) 10, an apparatus for creation of a chronology mapping of text to an audio recording. FIG. 3 depicts Phonographeme Player (“Player”) 50, an apparatus for animating and displaying text and for synchronizing the animation of the text with playing of the audio.

All components and modules of the present invention depicted herein may be implemented in any combination of hardware, software, and/or firmware. When implemented in software, said components and modules can be embodied in any computer-readable medium or media, such as one or more hard disks, floppy disks, CD's, DVD's, etc.

Mapper 10 (executing on processor 2) receives input data from memory 3, non-volatile digital storage 4, and/or network 9 via network adapter 7. The input data has two components, typically implemented as separate files: audio recording 11 and text 12.

Audio recording 11 is a digital representation of sound of arbitrary length, encoded in a format such as MP3, OOG, or WAV. Audio recording 11 typically includes spoken speech.

Text 12 is a digital representation of written text or glyphs, encoded in a format such as ASCII or Unicode. Text 12 may also be a representation of MIDI (Musical Instrument Digital Interface) or any other format for sending digitally encoded information about music between or among digital computing devices or electronic devices. Text 12 typically consists of written words of a natural language.

Audio recording 11 and text 12 have an intrinsic correspondence. One example is an audio recording 11 of a speech and the text 12 or script of the speech. Another example is an audio recording 11 of a song and the text 12 or lyrics of the song. Yet another example is an audio recording 11 of many bird songs and textual names 12 of the bird species. A chronology mapping (jana list 16) formalizes this intrinsic correspondence.

Marko list 14 is defined as a list of beginning-and-ending-time pairs (mark-on, mark-off), expressed in seconds or some other unit of time. For example, the pair of numbers 2.000:4.500 defines audio data in audio recording 11 that begins at 2.000 seconds and ends at 4.500 seconds.

Restrictions on markos 14 include that the second number of the pair is always greater than the first, and markos 14 do not overlap.

Token list 15 is a list of textual or symbolic representations of the corresponding markos 14.

A marko 14 paired with a textual or symbolic representation 15 of the corresponding marko is called a jana 16 (pronounced yaw-na). For example, the audio of the word “hello” that begins at 2.000 seconds and ends at 4.500 seconds in audio recording 11 is specified by the marko 2.000:4.500. The marko 2.000:4.500 and the token “hello” specify a particular jana 16. Note that a jana 16 is a pair 14 of numbers and a token 15—a jana 16 does not include the actual audio data 11.

A jana list 16 is a combination of the marko list 14 and the token list 15. A jana list 16 defines a chronology mapping between the audio recording 11 and the text 12.

A mishcode (mishmash code) is defined as a jana 16 whose token 15 is symbolic rather than textual. Examples of audio segments that might be represented as mishcodes are silence, applause, coughing, instrumental-only music, or anything else that is chosen to be not represented textually. For example, the sound of applause beginning at 5.200 seconds and ending at 6.950 seconds in an audio recording 11 is represented by the marko 5.200:6.950 paired with the token “<mishcode>”, where “<mishcode>” refers to a particular mishcode. Note that a mishcode is a category of jana 16.

A mishcode 16 supplied with a textual representation is no longer a mishcode. For example, the sound of applause might be represented by the text “clapping”, “applause”, or “audience breaks out in applause”. After this substitution of text for the “<mishcode>” token, it ceases to be a miscode, but it is still a jana 16. Likewise, a jana 16 with textual representation is converted to a mishcode by replacing the textual representation with the token “<mishcode>”.

The audio which each jana represents can be saved as separate audio recordings 17, typically computer files called split files. Lists 14-16 and files 17 can be stored on non-volatile digital storage 4.

Display 20 coupled to video processor 6 provides visual feedback to the user of digital computing device 100. Speaker 30 coupled to audio processor 5 provides audio feedback to the user. User input 40, such as a mouse and/or a keyboard, coupled to input processor 1 and thence to Mapper 10, provides user control to Mapper 10.

In one embodiment, Mapper 10 displays four window panes on display 20: marko pane 21, token pane 22, controls pane 23, and volume graph pane 24. In other embodiments, the Mapper's functionality can be spread differently among a fewer or greater number of panes.

Marko pane 21 displays markos 14, one per line. Optionally, pane 21 is scrollable. This pane 21 may also have interactive controls.

Token pane 22 displays tokens 15, one per line. Pane 22 is also optionally scrollable. This pane 22 may also have interactive controls.

Controls pane 23 displays controls for editing, playing, saving, loading, and program control.

Volume graph pane 24 displays a volume graph of a segment of the audio recording 11. This pane 24 may also have interactive controls.

Operation of the system depicted in FIG. 2 will now be described.

Audio recording 11 is received by Mapper 10, which generates an initial marko list 14, and displays said list 14 in marko pane 21. The initial marko list 14 can be created by Mapper 10 using acoustic analysis of the audio recording 11, or else by Mapper 10 dividing recording 11 into fixed intervals of arbitrary preselected duration.

The acoustic analysis can be done on the basis of the volume of audio 11 being above or below preselected volume thresholds for particular preselected lengths of time.

There are three cases considered in the acoustic analysis scan: (a) an audio segment of the audio recording 11 less than volume threshold V1 for duration D1 or longer is categorized as “lull”; (b) an audio segment 11 beginning and ending with volume greater than threshold V2 for duration D2 or longer and containing no lulls is categorized as “sound”; (c) any audio 11 not included in either of the above two cases is categorized as “ambiguous”.

Parameters V1 and V2 specify volume, or more precisely, acoustic power level, such as measured in watts or decibels. Parameters D1 and D2 specify intervals of time measured in seconds or some other unit of time. All four parameters (V1, V2, D1, and D2) are user selectable.

Ambiguous audio is then resolved by Mapper 10 into either neighboring sounds or lulls. This is done automatically by Mapper 10 using logical rules after the acoustic analysis is finished, or else by user intervention in controls pane 23. At the end of this step, there will be a list of markos 14 defining each of the sounds in audio recording 11; this list is displayed in marko pane 21.

Creation of an initial marko list 14 using fixed intervals of an arbitrary duration requires that the user select a time interval in controls pane 23. The markos 14 are the selected time interval repeated to cover the entire duration of audio recording 11. The last marko 14 of the list may be shorter than the selected time interval.

Text 12 is received by Mapper 10, and an initial token list 15 is generated by Mapper 10 and displayed in token pane 22. The initial token list 15 can be created by separating the text 12 into elements (tokens) 15 on the basis of punctuation, words, or meta-data such as HTML tags.

The next step is an interactive process by which the user creates a correspondence between the individual markos 14 and the tokens 15.

A user can select an individual marko 14 from marko pane 21, and play its corresponding audio from audio recording 11 using control pane 23. The audio is heard from speaker 30, and a volume graph of the audio is displayed in volume graph pane 24. Marko pane 21 and token pane 22 show an approximate correspondence between the markos 14 and tokens 15. The user interactively refines the correspondence by using the operations described next.

Marko operations include “split”, “join”, “delete”, “crop”, and “play”. Token operations include “split”, “join”, “edit”, and “delete”. The only operation defined for symbolic tokens is “delete”. Depending on the particular embodiment, marko operations are performed through a combination of the marko, controls, and volume graph panes (21, 23, 24, respectively), or via other user input 40. Depending on the particular embodiment, token operations are performed through a combination of the token pane 22 and controls pane 23, or via other user input 40.

A marko split is the conversion of a marko in marko pane 21 into two sequential markos X and Y, where the split point is anywhere in between the beginning and end of the original marko 14. Marko X begins at the original marko's beginning, marko Y ends at the original marko's end, and marko X's end is the same as marko Y's beginning. That is the split point. The user may consult the volume graph pane 24, which displays a volume graph of the portion of audio recording 11 corresponding to the current jana 16, to assist in the determination of an appropriate split point.

A marko join is the conversion of two sequential markos X and Y in marko pane 21 into a single marko 14 whose beginning is marko X's beginning and whose end is marko Y's end.

A marko delete is the removal of a marko from the list 14 of markos displayed in marko pane 21.

A marko crop is the removal of extraneous information from the beginning or end of a marko 14. This is equivalent to splitting a marko 14 into two markos 14, and discarding the marko 14 representing the extraneous information.

A marko play is the playing of the portion of audio recording 11 corresponding to a marko 14. While playing this portion of audio recording 11 is produced on speaker 30, a volume graph is displayed on volume graph pane 24, and the token 15 corresponding to the playing marko 14 is highlighted in token pane 22. “Highlighting” in this case means any method of visual emphasis.

Marko operations are also defined for groups of markos: a marko 14 may be split into multiple markos, multiple markos 14 may be cropped by the same amount, and multiple markos 14 may be joined, deleted, or played.

A token split is the conversion of a token 15 in token pane 22 into two sequential tokens X and Y, where the split point is between a pair of letters, characters, or glyphs.

A token join is the conversion of two sequential tokens X and Y in token pane 22 into a single token 15 by textually appending token Y to token X.

“Token edit” means textually modifying a token 15; for example, correcting a spelling error.

“Token delete” is the removal of a token from the list 15 of tokens displayed in token pane 22.

At the completion of the interactive process, every marko 14 will have a corresponding token 15; the pair is called a jana 16 and the collection is called the jana list 16.

The user may use a control to automatically generate mishcodes for all intervals in audio recording 11 that are not included in any marko 14 of the jana list 16 of the audio recording 11.

The jana list 16 can be saved by Mapper 10 in a computer readable form, typically a computer file or files. In one embodiment, jana list 16 is saved as two separate files, marko list 14 and token list 15. In another embodiment, both are saved in a single jana list 16.

The methods for combining marko list 14 and token list 15 into a single jana file 16 include: (a) pairwise concatenation of the elements of each list 14, 15, (b) concatenation of one list 15 at the end of the other 14, (c) defining XML or other meta-data tags for marko 14 and token 15 elements.

An optional function of Mapper 10 is to create separate audio recordings 17 for each of the janas 16. These recordings are typically stored as a collection of computer files known as the split files 17. The split files 17 allow for emulation of streaming without using an underlying streaming protocol.

To explain how this works, a brief discussion of streaming follows. In usual streaming of large audio content, a server and a client must have a common streaming protocol. The client requests a particular piece of content from a server. The server begins to transmit the content using the agreed upon protocol. After the server transmits a certain amount of content, typically enough to fill a buffer in the client, the client can begin to play it. Fast-forwarding of the content by the user is initiated by the client sending a request, which includes a time-code, to the server. The server then interrupts the transmission of the stream, and re-starts the transmission from the position specified by the time-code received from the client. At this point, the buffer at the client begins to refill.

The essence of streaming is (a) a client sends a request to a server, (b) the server commences transmission to the client, (c) the client buffer fills, and (d) the client begins to play.

A discussion of how this invention emulates streaming is now provided. A client (in this case, external computer 31) requests the jana list 16 for a particular piece of content from a server (in this case, processor 2). Server 2 transmits the jana list 16 as a text file using any file transfer protocol. The client 31 sends successive requests for sequential, individual split files 17 to server 2. Server 2 transmits the requested files 17 to the client 31 using any file transfer protocol. The sending of a request and reception of a corresponding split file 17 can occur simultaneously and asynchronously. The client 31 can typically begin to play the content as soon as the first split file 17 has completed its download.

This invention fulfills the normal requirements for the streaming of audio. The essence of this method of emulating streaming is (a) client 31 sends a request to server 2, (b) server 2 commences transmission to client 31, (c) client 31 receives at least a single split file 17, and (d) client 31 begins to play the split file 17.

This audio delivery method provides the benefits of streaming with additional advantages, including the four listed below:

(1) The present invention frees content providers from the necessity of buying or using specialized streaming server software, since all content delivery is handled by a file transfer protocol rather than by a streaming protocol. Web servers typically include the means to transfer files. Therefore, this invention will work with most, or all, Web servers; no streaming protocol is required.

(2) The present invention allows playing of ranges of audio at the granularity of janas 16 or multiples thereof. Note that janas 16 are typically small, spanning a few seconds. Streaming protocols cannot play a block or range of audio in isolation—they play forward from a given point; then, the client must separately request that the server stop transmitting once the client has received the range of content that the user desires.

(3) In the present invention, fast forward and random access are intrinsic elements of the design. Server 2 requires no knowledge of the internal structure of the content to implement these functional elements, unlike usual streaming protocols, which require that the server have an intimate knowledge of the internal structure. In the present invention, client 31 accomplishes a fast forward or random access by sending sequential split file 17 requests, beginning with the split file 17 corresponding to the point in the audio at which playback should start. This point is determined by consulting the jana list 16, specifically the markos 14 in the jana list 16 (which was previously transferred to client 31). All servers 2 that do file transfer can implement the present invention.

(4) The present invention ameliorates jumpiness in speech playback when data transfer speed between client 31 and server 2 is not sufficient to keep up with audio playback in client 31. In a streaming protocol, audio playback will pause at an unpredictable point in the audio stream to refill the client's buffer. In streaming speech, such points are statistically likely to occur within words. In the present invention, such points occur only at jana 16 boundaries. In the case of speech, janas 16 conform to natural speech boundaries, typically defining beginning and ending points of syllables, single words, or short series of words.

Player 50, executing on processor 2, receives input data from memory 3, non-volatile digital storage 4, and/or network 9 via network adapter 7. The input data has at least two components, typically implemented as files: a jana list 16 and a set of split files 17. The input data may optionally include a set of annotation files and index 56.

The jana list 16 is a chronology mapping as described above. The split files 17 are audio recordings as described above. List 16 and files 17 may or may not have been produced by the apparatus depicted in FIG. 2.

The set of annotation files and index 56 are meta-data comprised of annotations, plus an index. Annotations can be in arbitrary media formats, including text, audio, images, video clips, and/or URLs, and may have arbitrary content, including definitions, translations, footnotes, examples, references, clearly enunciated pronunciations, alternate pronunciations, and quizzes (in which a user is quizzed about the content). The token 15, token group, textual element, or time-code 14 to which each individual annotation belongs is specified in the index. In one embodiment, annotations themselves may have annotations.

Display 20, coupled to video processor 6, provides visual feedback to the user. Speaker 30, coupled to audio processor 5, provides audio feedback to the user. User input 40, such as a mouse and/or a keypad, coupled to input processor 1, provides user control.

Player 50 displays a window pane on display 20. In one embodiment, the window pane has three components: a text area 61, controls 62, and an optional scrollbar 63. In other embodiments, the Player's functionality can be spread differently among a fewer or greater number of visual components.

The text area 61 displays tokens 15 formatted according to user selected criteria, including granularity of textual elements, such as word, phrase, sentence, or paragraph granularity. Examples of types of formatting include one token 15 per line, one word per line, as verses in the case of songs or poetry, or as paragraphs in the case of a book. Component 61 may also have interactive controls.

The controls component 62 displays controls such as audio play, stop, rewind, fast-forward, loading, animation type, formatting of display, and annotation pop-up.

Optional scrollbar 63 is available if it is deemed necessary or desirable to scroll the text area 61.

Operation of the system depicted in FIG. 3 will now be described.

Player 50 requests the jana list 16 for a particular piece of content, and associated annotation files and index 56, if it exists. The jana list 16 is received by Player 50, and the text area 61 and controls 62 are displayed. The corresponding token list 15 is displayed in the text area 61.

Player 50 can be configured to either initiate playback automatically at startup, or wait for the user to initiate playback. In either case, Player 50 plays a jana 16 or group of janas 16. The phrase “group of janas” covers the cases of the entire jana list 16 (beginning to end), from a particular jana 16 to the last jana 16 (current position to end), or between two arbitrary janas 16.

Playback can be initiated by the user activating a start control which plays the entire jana list 16, by activating a start control that plays from the current jana 16 to the end, or by selecting an arbitrary token 15 or token group in the text area 61 using a mouse, keypad, or other input device 40 to play the corresponding jana 16 or janas 16.

The playing of a jana 16 is accomplished by playing the corresponding split file 17. Player 50 obtains the required split file 17, either from the processor 2 on which Player 50 is running, from another computer, or from memory 3 if the split file 17 has been previously obtained and cached there.

If multiple split files 17 are required, and those files 17 are not in cache 3, Player 50 initiates successive requests for the needed split files 17.

The initiation of playback starts a real-time clock (coupled to Player 50) initialized to the beginning time of the marko 14 in the jana 16 being played.

The real-time clock is synchronized to the audio playback; for example, if audio playback is stopped, the real-time clock stops, or if audio playback is slow, fast, or jumpy, the real-time clock is adjusted accordingly.

The text is animated in time with this real-time clock. Specifically, the token 15 of a jana 16 is animated during the time that the real-time clock is within the jana's marko interval. Additionally, if the text of the currently playing jana 16 is not visible within text area 61, text area 61 is automatically scrolled so as to make the text visible.

Animation of the text includes all cases in which the visual representation of the text changes in synchrony with audio playback. The animation and synchronization can be at the level of words, phrases, sentences, or paragraphs, but also at the level of letters, phonemes, or syllables that make up the text, thus achieving a close, smooth-flowing synchrony with playback of the corresponding audio recording.

Text animation includes illusions of motion and/or changes of color, font, transparency, and/or visibility of the text or of the background. Illusions of motion may occur word by word, such as the bouncing ball of karaoke, or text popping up or rising away from the baseline. Illusions of motion may also occur continuously, such as a bar moving along the text, or the effect of ticker tape. The animation methods may be used singly or in combination.

If annotation files and index 56 were available for the current jana list 16, then the display, play, or pop-up of the associated annotations are available. The annotation files and index 56 containing the text, audio, images, video clips, URLs, etc., are requested on an as-needed basis.

The display, play, or pop-up of annotations are either user-triggered or automatic.

User-triggered annotations are displayed by user interaction with the text area 61 on a token 15 or textual element basis. Examples of methods of calling up user-triggered annotations include selecting a word, phrase, or sentence using a mouse, keypad, or other input device 40.

Automatic annotations, if enabled, can be triggered by the real-time clock, using an interval timer, from external stimuli, or at random. Examples of automatic annotations include slide shows, text area backgrounds, or audio, visual, or textual commentary.

Three specific annotation examples are: (a) a right-mouse-button click on the word “Everest” in text area 61 pops up an image of Mount Everest; (b) pressing of a translation button while the word “hello” is highlighted in text area 61 displays the French translation “bonjour”; (c) illustrative images of farmyard animals appear automatically at appropriate times during playing of the song “Old MacDonald”.

In one embodiment, Player 50, jana list 16, split files 17, and/or annotation files and index 56 are integrated into a single executable digital file. Said file can be transferred out of device 100 via network adapter 7.

While the invention has been described in connection with preferred embodiments, said description is not intended to limit the scope of the invention to the particular forms set forth, but on the contrary, it is intended to cover such alternatives, modifications, and equivalents as may be included within the spirit and scope of the invention.

What is claimed is:

1. At least one computer-readable medium containing computer program instructions for creating a chronology mapping of text to an audio recording, said computer program instructions performing the steps of:
feeding, as inputs to a computer-implemented mapper module, text in computer-readable form and an audio recording in computer-readable form, said audio recording corresponding to the text; and
assigning beginning and ending times to elements within the text at an arbitrary level of granularity.

2. The at least one computer-readable medium of claim 1 wherein the level of granularity is a level from the group of levels consisting of fixed duration, letter, phoneme, syllable, word, phrase, sentence, and paragraph.

3. The at least one computer-readable medium of claim 1 further comprising the step of producing multiple audio recordings at the same level of granularity as the elements, by splitting the audio recording input at beginning and ending time boundaries.

4. The at least one computer-readable medium of claim 3 further comprising the step of using said multiple audio recordings to implement characteristics of audio streaming without using an underlying streaming protocol.

5. The at least one computer-readable medium of claim 1 wherein said text is in a format from the group of formats consisting of ASCII, Unicode, MIDI, and any format for sending digitally encoded information about music between or among digital computing devices or electronic devices.

6. The at least one computer-readable medium of claim 1 further comprising the step of assigning annotations to said elements, wherein:
the annotations are in a format from the group of formats consisting of text, audio, images, video clips, URLs, and an arbitrary media format; and
the annotations have arbitrary content from the group of content consisting of definitions, translations, footnotes, examples, references, pronunciations, and quizzes in which a user is quizzed about the content.

7. The at least one computer-readable medium of claim 1 further comprising the step of saving said beginning and ending times and said elements in computer-readable form.

8. A computer-implemented method for creating a chronology mapping of text to an audio recording, said method comprising the steps of:
feeding, as inputs to a computer-implemented mapper module, text in computer-readable form and an audio recording in computer-readable form, said audio recording corresponding to the text;
assigning beginning and ending times to elements within the text at an arbitrary level of granularity; and
producing structured text based on the elements and further based on the beginning and ending times of the elements.

9. The computer-implemented method of claim 8 wherein the structured text is text from the group of text consisting of HTML, XML, and simple delimiters; and
structure indicated by the structured text includes at least one of boundaries of elements, hierarchies of elements at different levels of granularity, and correspondence between elements and the beginning and ending times of the elements.

10. Apparatus for creation of a chronology mapping of text to an audio recording, said apparatus comprising:
a computer-implemented mapper module having as inputs text in computer-readable form and an audio recording in computer-readable form, said audio recording corresponding to the text;
means for assigning beginning and ending times to elements within the text at an arbitrary level of granularity; and
interactive means for selecting at least one of the elements and the granularity of the elements.

11. The apparatus of claim 10 wherein the selecting means further permits changing, expanding, and/or contracting the granularity interactively.

12. Apparatus for animating text and displaying said animated text in synchrony with an audio recording, said apparatus comprising:
a computer-implemented player module having as inputs text, an audio recording corresponding to said text, and a chronological mapping between the text and the audio recording; wherein:
said player module animates the text, displays the text, and synchronizes the displayed text with playing of the audio recording;
said animation causes the displayed text to change in synchrony with the playing of the audio recording; and
said animation and synchronization are at the level of letters, phonemes, or syllables that make up the text, thus achieving synchrony with playback of the corresponding audio recording.

13. The apparatus of claim 12 wherein said text is written text and said audio recording is a recording of spoken words.

14. A computer-implemented method for animating text and displaying said animated text in synchrony with an audio recording, said method comprising the steps of:
feeding, as inputs to a computer-implemented player module, text, an audio recording corresponding to said text, and a chronological mapping between the text and the audio recording; wherein:
said player module animates the text, displays the text, and synchronizes the displayed text with playing of the audio recording;
said animation causes the displayed text to change in synchrony with the playing of the audio recording; and
said animation and synchronization are at the level of letters, phonemes, or syllables that make up the text, thus achieving synchrony with playback of the corresponding audio recording.

15. The computer-implemented method of claim 14 further comprising the step of displaying annotations assigned to textual elements, wherein the displayed annotations are triggered by user interaction on a textual element basis, or else are triggered automatically.

16. The computer-implemented method of claim 15 wherein:
the annotations are triggered by user interaction on a textual element basis; and
the basis is user selection, using a pointer or input device, of a letter, phoneme, syllable, word, phrase, sentence, or paragraph.

17. At least one computer-readable medium containing computer program instructions for animating text and displaying said animated text in synchrony with an audio recording, said computer program instructions performing the steps of:
feeding, as inputs to a computer-implemented player module, text, an audio recording corresponding to said text, and a chronological mapping between the text and the audio recording; wherein:
said player module animates the text, displays the text, and synchronizes the displayed text with playing of the audio recording;
said animation causes the displayed text to change in synchrony with the playing of the audio recording; and
said animation and synchronization are at the level of letters, phonemes, or syllables that make up the text, thus achieving synchrony with playback of the corresponding audio recording.

18. The at least one computer-readable medium of claim 17 wherein at least two of said player module, said text, said audio recording, and said mapping are integrated in a single executable digital file.

19. The at least one computer-readable medium of claim 17 further comprising the step of transferring, via a network connection, at least one of said player module, said text, said audio recording, and said mapping.

20. The at least one computer-readable medium of claim 17 further comprising the step of displaying annotations assigned to textual elements, wherein the displayed annotations are triggered by user interaction on a textual element basis, or else are triggered automatically.

21. The at least one computer-readable medium of claim 20 wherein:
the annotations are triggered by user interaction on a textual element basis; and
the basis is user selection, using a pointer or input device, of a letter, phoneme, syllable, word, phrase, sentence, or paragraph.

22. A computer-implemented method for transmitting audio recordings, said method comprising the steps of:
a client computer requesting that a server computer send to the client computer audio segments from a longer audio recording, said segments having time intervals of arbitrary durations; and
responsive to said request from said client computer, said server computer sending said audio segments to said client computer.

23. The computer-implemented method of claim 22 wherein:
the audio segments are in the form of a collection of computer files; and
said server computer sends to said client computer said audio segments using a file transfer protocol.

24. The computer-implemented method of claim 22 wherein:
the longer audio recording contains speech; and
the audio segments are specified by beginning and ending points of syllables, single words, and/or series of words.

25. The computer-implemented method of claim 22 further comprising the step of using said transmitted audio segments to implement characteristics of audio streaming without using an underlying streaming protocol.
